(19) United States
(12) Patent Application Publication
(10) Pub. No.: US 2009/0091541 A1
(43) Pub. Date: Apr. 9, 2009

(54) Method for controlling appearing and disappearing of screen keyboard tables

(76) Inventor: Stephen Chen, Shengang Shiang (TW)

Correspondence Address: BRUCE H. TROXELL, SUITE 1404, 5205 LEESBURG PIKE, FALLS CHURCH, VA, 22041, US

(21) Appl. No.: 11/907,025

(22) Filed: Oct. 9, 2007

(51) Int. Cl. G06F 3/041

(52) U.S. Cl. 345/173

(57) ABSTRACT

A method for controlling appearing and disappearing of screen keyboard tables includes at least the following steps: (1) triggering: present the keyboard tables on a screen when a touch panel is touched by a user's finger; (2) depressing the touch panel: user's finger depresses each character segment on the touch panel and a corresponding character is input; and (3) entering an ending character: enter an ending character, and the keyboard tables disappear from the screen. Thus the convenience of data entry for users is enhanced and the keyboard tables are concealed as desired to facilitate user review.

### BACKGROUND OF THE INVENTION

1. Field of the Invention

The present invention relates to a method for controlling appearing and disappearing of screen keyboard tables to enhance input convenience and conceal the keyboard tables as desired to facilitate user review.

2. Description of the Prior Art

Computers are increasingly made portable nowadays. They can be carried easily to enable users to use anywhere anytime. The present notebook computers generally have two panels foldable into one set. One panel is for holding a computer screen, while another is for holding a keyboard. When in use they are unfolded in a vertical manner against each other to be rested on a table to facilitate operation. However, such an approach is inconvenient for handheld operation. To meet the requirement of handheld operation, a tablet computer is usually adopted. The tablet computer has the screen located on the chassis so that a user can hold the computer with one hand while hold a stylus with other hand to touch a touch screen to select function keys or do writing.

Although the tablet computer can be operated in a handheld manner, many important computer tasks involve text entry. The tablet computer relies on the touch stylus as the main input means. It requires more labors than the conventional keyboard to do data entry, and the entry speed also is much slower. Hence although it offers improvement in carrying, it has disadvantages in input operation. As a result, the tablet computer is still not yet widely accepted on the market. It mainly is limited to some specific applications, such as for doctor's touring wards, stocktaking, and the like that require merely ticking on selected items, but do not need much data entry.

Another approach adopts a two-stage depressing touch panel in cooperating with a keyboard table displayed on a screen. When a user's finger touches a corresponding character on the touch panel, a special mark is made on the keyboard table, when depressed the character is input. The touch panel may also be designed with a click sense during depressing. A plurality of two-stage depressing touch panels may be provided to form a corresponding keyboard table on a screen to allow more fingers to operate at the same time. The operation is close to the conventional keyboard. But it is formed at a very small size. As the keyboard layout and finger touch position can be displayed on the screen, some even adopt a design that is operable at the back side of the chassis.

The methods set forth above need to display a keyboard table on the screen. The keyboard table occupies a portion of the screen. As the touch screen has to be depressed by user's fingers, the keyboard table usually is formed at a larger size to facilitate operation, thus masks a great portion of the display area. Therefore to make the keyboard table to automatically appear on the screen when needed and automatically disappear when not needed is an issue hotly pursued in the industry.

### SUMMARY OF THE INVENTION

In general, many computer tasks do not require much text entry, such as surfing the Internet, playing video games or seeing movies. However, some tasks frequently require text entry, such as writing (reply) e0mail, MSN, editing texts and the like. During writing a keyboard table has to be appeared on the screen. However, in the writing process users often want to review the writing outcomes and text structure, and at that moment they want the keyboard table to disappear without hindering the screen. Most users generally have a habit of reviewing the input result after finishing the entry of one word or even a complete sentence.

To resolve the disadvantages of the conventional approaches previously discussed, a desirable solution is to make the keyboard table to disappear temporarily when a user has entered an ending character, such as the space key, period mark, comma, question mark, colon, or even the enter key is hit. And the keyboard table appears again after the touch panel or touch screen has been touched. Such an approach can reduce the inconvenience of the screen masked by the keyboard table.

Therefore the primary object of the invention is to provide a method for controlling appearing and disappearing of screen keyboard tables. This method enables the keyboard tables to flexibly and automatically appear on a screen to be used for text entry and to automatically disappear during review of the input result to avoid masking the text.

To achieve the foregoing object the method of the invention includes at least the steps of: (1) triggering: present a keyboard table on a screen when a touch panel is touched by a user's finger; (2) depressing the touch panel: user's finger depresses each character segment and a corresponding character is input; and (3) entering an ending character: enter the ending character, and the keyboard table disappears from the screen.

In the method of the invention the touch panel includes one or a plurality of touch panels responsive to depressing. Each touch panel is divided into a plurality of character segments according to coordinates. Each character segment represents a character. When the touch panel is depressed, the character represented by the character segment which is touched by the user's finger is input.

In one aspect, at the step of entering an ending character the ending character is a punctuation mark such as comma, period, question mark, exclamation mark, colon and space that aims to end a sentence.

In another aspect, the step of depressing the touch panel further includes a step of overtime calculation. Aside from entering the ending character, when the duration of user's finger not touching the touch panel exceeds a set time period the keyboard table on the screen disappears.

In yet another aspect, the step of entering an ending character further includes a step of entering an editing position adjustment character. Aside from the ending characters, the entered character may be an editing position adjustment character (such as directional keys of up, down, left and right, backspace key, enter key, space key, TAB key or the like). Then the keyboard table also automatically disappears from the screen, while the touch panel maintains text entry function.

In yet another aspect, the keyboard table includes a temporary editor. During text entry the entered characters are temporarily displayed on the temporary editor to form a character string. When an ending character is entered the keyboard table disappears, and the character string on the temporary editor is moved to a text to be edited to allow the user to do overall review.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is an operational flow chart of the invention.

FIG. 3 is an operational flow chart of a second embodiment of the invention.

FIG. 4 is an operational flow chart of a third embodiment of the invention.

FIG. 5 is a schematic view of operation condition-1 of the invention.

FIG. 6 is a schematic view of operation condition-2 of the invention.

FIG. 7 is a schematic view of operation condition-3 of the invention.

FIG. 8 is a schematic view of operation condition-4 of the invention.

FIG. 9 is a schematic view of operation condition-5 of the invention.

FIG. 10 is a schematic view of operation condition-6 of the invention.

### DESCRIPTION OF THE PREFERRED EMBODIMENTS

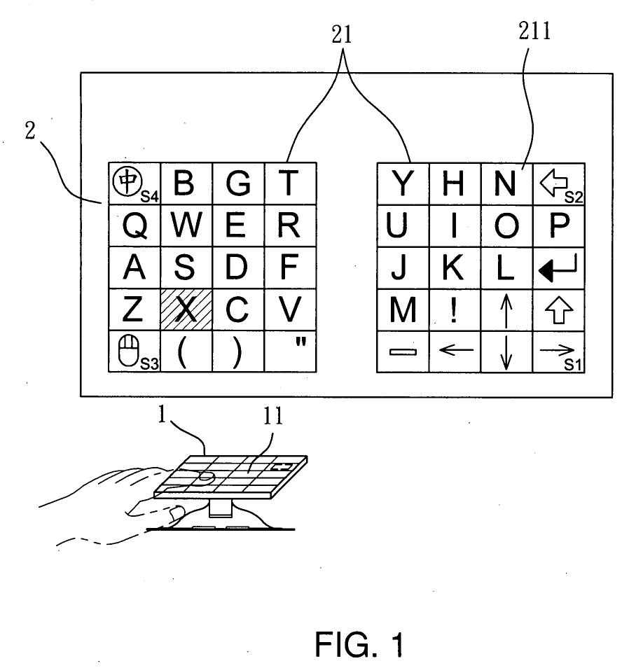

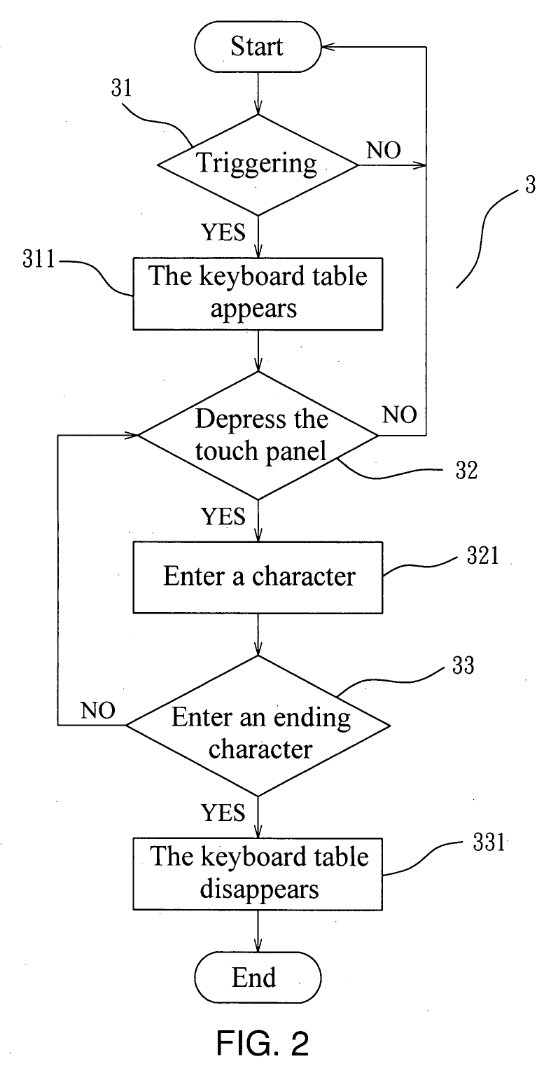

Referring to FIG. 1, to implement the method of the invention, at least one touch panel 1 responsive to depressing is provided that is divided into a plurality of segments 11 to mate a keyboard table 21 displayed on a screen 2 (the keyboard table 21 has a content definition changeable by a system). Each of the segments 11 corresponds to a character 211 on the keyboard table 21. When the touch panel 1 is depressed, user's finger touches the segment 11, then the character 211 corresponding to the segment is input. By means of the combination of elements set forth above the method 3 of the invention can be carried out through at least the following steps (referring to FIG. 2):

1. triggering (step 31): present the keyboard table 21 on the screen 2 when the touch panel 1 is touched by a user's finger;

2. depressing the touch panel (step 32): user's finger depresses the character segment 11 on the touch panel 1, and a corresponding character is input (step 321); and

3. entering an ending character (step 33): when the input character is an ending character, the keyboard table 21 disappears from the screen 2, and the operation ends (step 331).

At the step of entering an ending character set forth above, the ending character is a punctuation mark such as comma, period, question mark, exclamation mark, colon and space that aims to end a sentence.

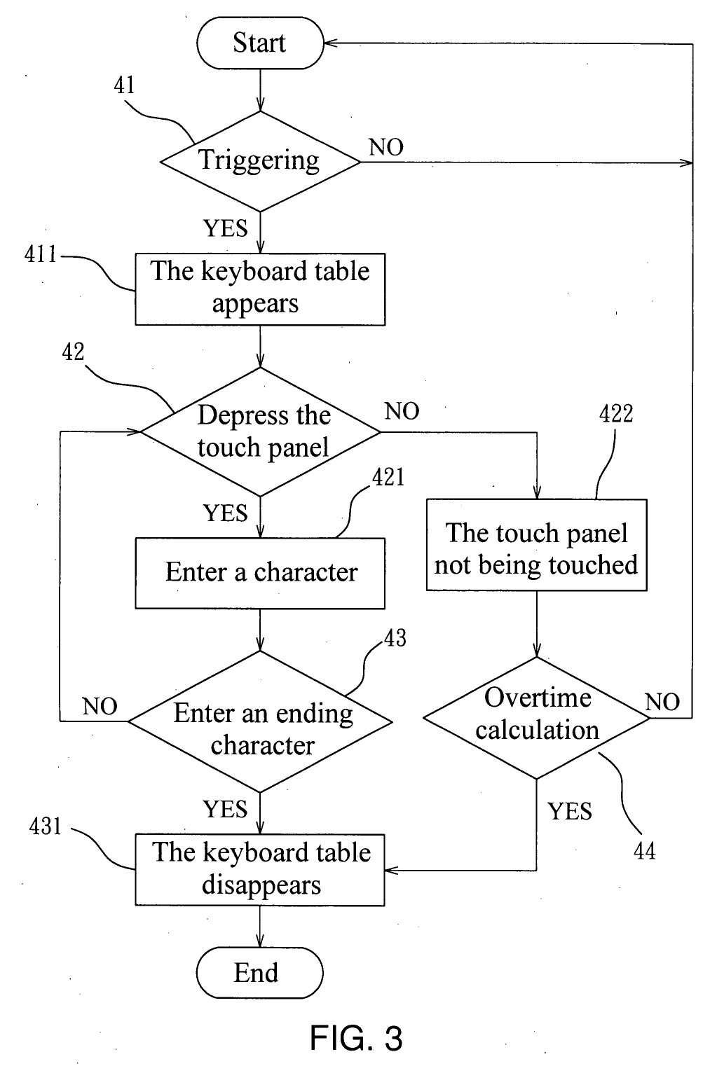

Refer to FIG. 3 for a second embodiment of the method 4 of the invention. When the duration of user's finger not touching the character segment 11 of the touch panel 1 exceeds a set time T period (which may be set according to user's requirement), the keyboard table 21 disappears to allow the user to do overall review. Steps 41, 411, 42, 421, 43 and 431 and operations thereof in the second embodiment are same as the embodiment previously discussed, thus details are omitted. In addition, the step of depressing the touch panel (step 42) set forth above further includes a step of overtime calculation (step 44) which is executed when the time of user's finger not touching the touch panel 1 exceeds a set time period T (steps 422 and 44), then the keyboard table 21 on the screen 2 disappears (step 431).

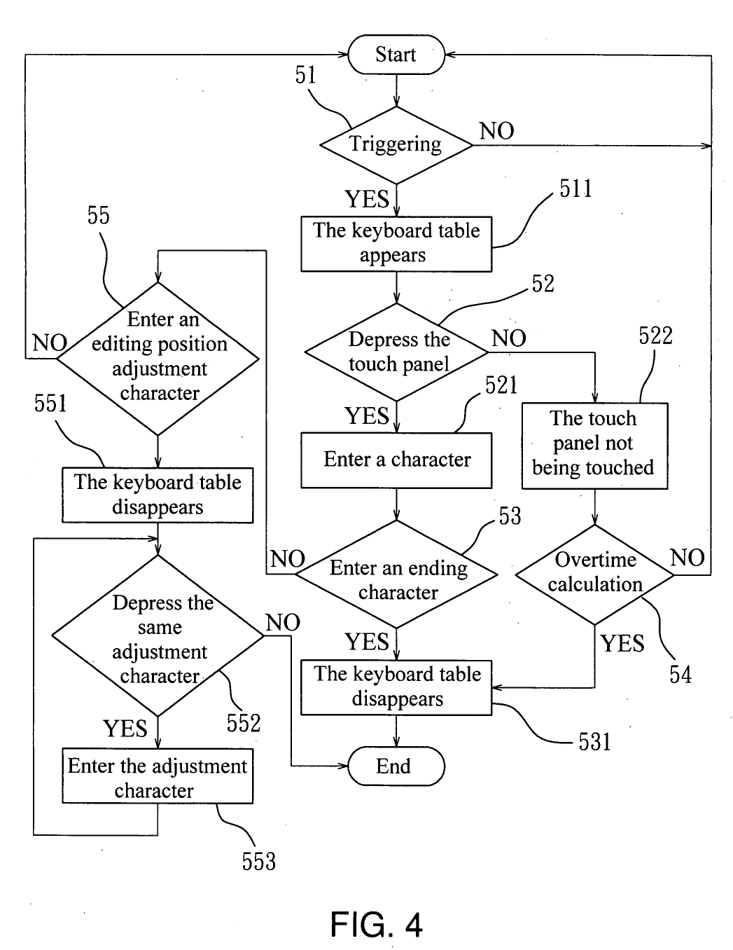

Refer to FIG. 4 for a third embodiment of the method 5 of the invention. Steps 51, 511, 52, 521, 522, 53, 531 and 54 and operations thereof are same as the second embodiment. In addition, the step of 53 for entering an ending character further includes a step 55 of “enter an editing adjustment character”. Namely the method 5 of the invention, aside from entering an ending character, also may enter an editing adjustment character, then the keyboard table 21 on the screen 2 disappears (step 551). However, the touch panel 1 (touch screen) still maintains text entry function. Hence when the user depresses the adjustment character one more time the process of entering the adjustment character is executed (steps 552 and 533).

At the steps 55 and 551 for “entering an editing position adjustment character”, the adjustment character includes directional keys of up, down, left and right, backspace key, enter key, space key, TAB key or the like.

By means of the steps previous discussed, the keyboard table 21 can flexibly and automatically appear on the screen 2 to allow text entry to be executed. During reviewing of the input result, the keyboard table 21 automatically disappears to avoid masking the text. A practical embodiment and operation are depicted as follow:

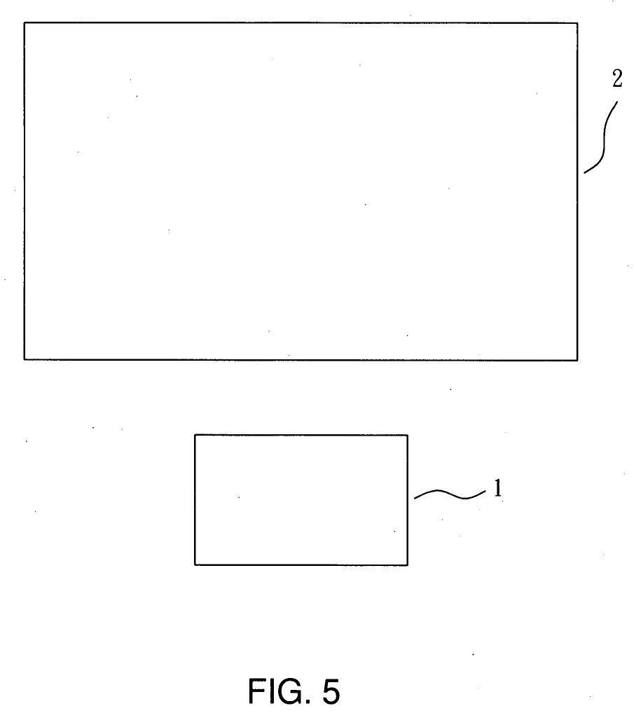

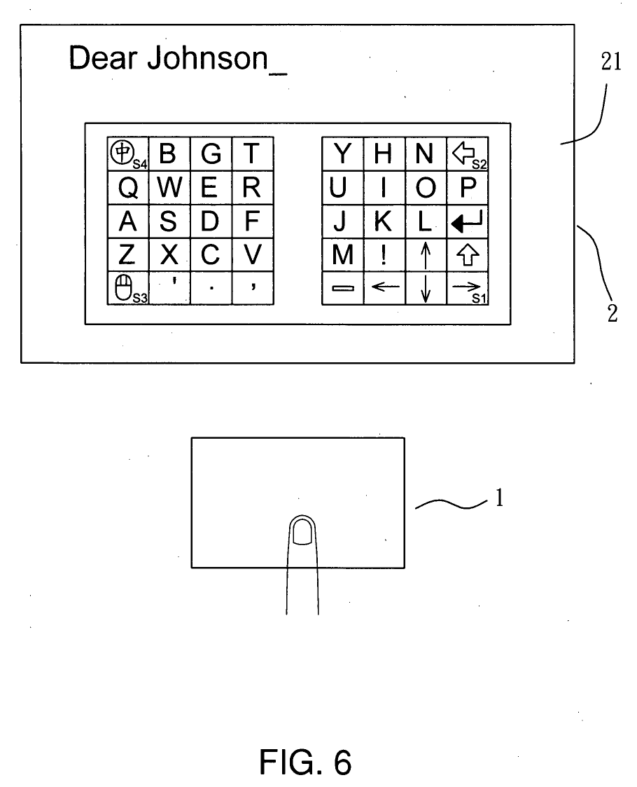

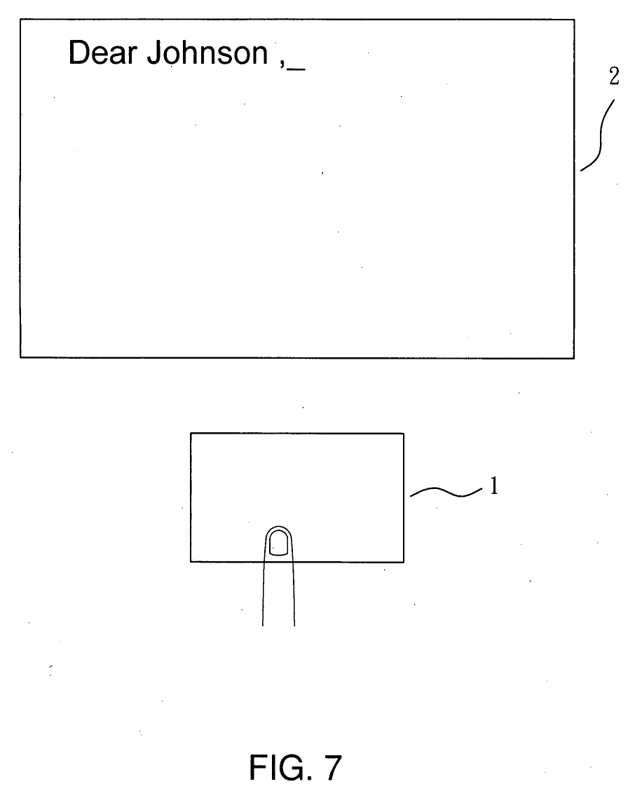

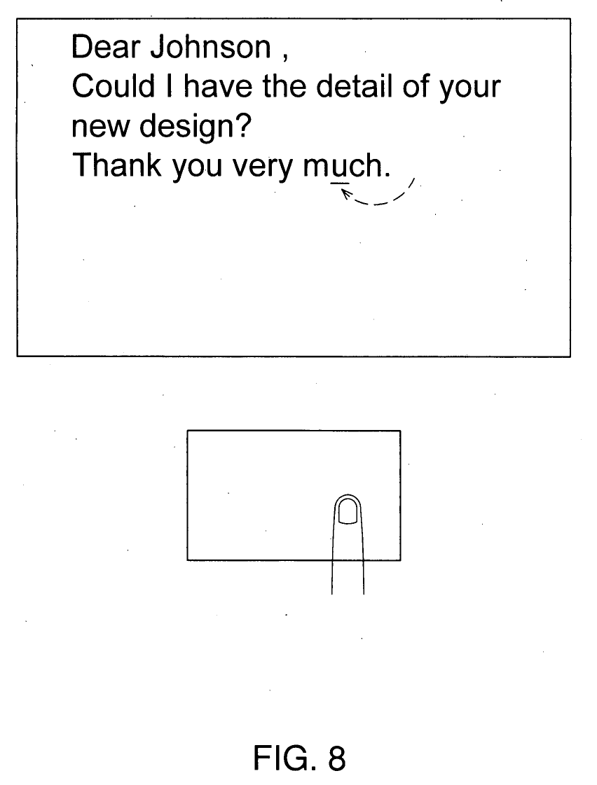

Referring to FIG. 5, when the touch panel 1 is not yet being touched, the keyboard table 21 is not displayed. When the touch panel 1 is touched by a user, the screen 2 displays the keyboard table 21 (referring to FIG. 6) to allow the user to enter text, for example “Dear Johnson”. When the user enters an ending character (such as comma), the keyboard table 21 disappears (referring to FIG. 7) to enable the user to review the input data. When the user enters an editing position adjustment character (such as the backspace key in FIG. 8), the keyboard table 21 also disappears to facilitate reviewing of the input position.

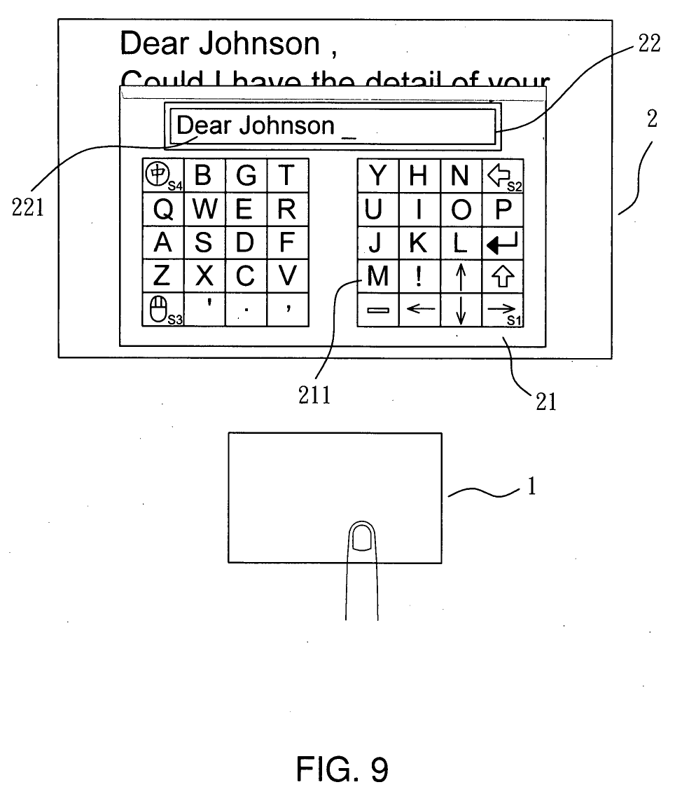

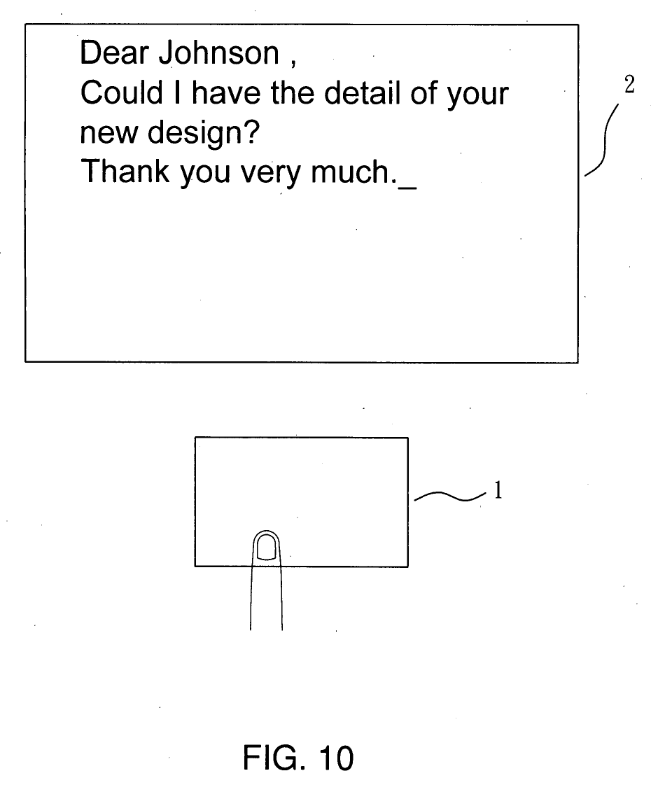

Referring to FIGS. 9 and 10, the keyboard table 21 further includes a temporary editor 22 to temporarily display the entered characters and form a character string 221 until an ending character is entered (such as the period shown in FIG. 10). Then the keyboard table 21 on the screen 2 disappears to allow the character string 221 on the temporary editor 22 to be moved to a desired editing text to allow the user to do overall review.

I claim:

1. A method for controlling appearing and disappearing of screen keyboard tables, comprising at least the steps of:
triggering to present a keyboard table on a screen by touching a user's finger on a touch panel;
depressing the touch panel with the user's finger on a character segment thereof corresponding to a character which is input; and
entering an ending character to make the keyboard table on the screen to disappear.

2. The method of claim 1, wherein the ending character at the step of entering an ending character is to end a sentence.

3. The method of claim 1, wherein the step of depressing the touch panel further includes another step of overtime calculation so that when the touch panel is not being touched by the user's finger for a duration which exceeds a set time period the keyboard table on the screen disappears.

4. The method of claim 1, wherein the step of entering an ending character further includes another step of entering an editing position adjustment character such that aside from entering the ending character the editing position adjustment character is allowed to be entered to make the keyboard table on the screen to disappear while the touch panel still maintains character entry function.

5. The method of claim 1, wherein the keyboard table further has a temporary editor to temporarily display input characters and form a character string, and to disappear the keyboard table from the screen when the ending character is entered and move the character string to a desired text to be edited to allow a user to perform overall review.

6. The method of claim 2, wherein the character to end a sentence includes keys representing comma, period, question mark, exclamation mark, colon and space.

7. The method of claim 4, wherein the adjustment character includes keys representing directions of up, down, left and right, a backspace key, an enter key, a space key and a TAB key.

8. The method of claim 4, wherein the touch panel is a touch screen.
